(19) United States
(12) Patent Application Publication
(10) Pub. No.: US 2025/0178419 A1
(43) Pub. Date: Jun. 5, 2025

(54) SIDE-FOLDABLE AND CONVERTIBLE TRUCK BED TONNEAU COVER-ROOF SYSTEM

(71) Applicant: Edmund Shen, Fremont, CA (US)

(72) Inventor: Edmund Shen, Fremont, CA (US)

(21) Appl. No.: 18/967,202

(22) Filed: Dec. 3, 2024

Related U.S. Application Data
(60) Provisional application No. 63/606,098, filed on Dec. 5, 2023.

(51) Int. Cl. B60J 7/14; B62D 35/00

(52) U.S. Cl. CPC B60J 7/141; B62D 35/00

(57) ABSTRACT

This utility patent presents a Side-Foldable and Convertible Truck Bed Tonneau Cover-Roof System, offering an innovative solution for vehicle multifunctional conversion, energy efficiency, and cargo area protection. The system features an automated, side-foldable tonneau cover that also functions as a roof, significantly enhancing aerodynamic efficiency, reducing energy consumption, and improving fuel economy. It provides robust weather protection and heightened security in the truck bed or cargo area for cargo, installed equipment, or robotics stored. With a one-touch operation, the system allows for smooth, seamless opening and closing, ensuring convenience and ease of use. This innovative design offers versatile functionality, transforming the tonneau cover into a portable vehicle roof. Additionally, it enables the conversion of a truck into various vehicle types, such as an SUV or van, or allows an SUV or van to be transformed into a truck, greatly enhancing the vehicle's versatility and adaptability. The system consists of three key components: watertight tonneau roof panels (typically 4 or 6), a motorized folding and retracting mechanism, and an automated side-pocket storage solution for the folded panels. The side pockets, located along the truck bed walls or van walls, allow for partial or full access to the bed or cargo area while securely storing the panels. The system can be installed as an original feature, retrofitted, or added as a portable upgrade on various vehicles with truck beds or cargo spaces, including trucks, pickup trucks, utility vehicles, passenger van, cargo van, and specialty vehicles, making it adaptable to a wide range of applications. This utility design provides both functional and aesthetic flexibility, allowing vehicles to be easily transformed based on user needs.

The present application claims priority to the earlier filed provisional application having Ser. No. 63606098, on Dec. 5, 2023, with the title as SIDE-FOLDABLE AND CONVERTIBLE TRUCK BED TONNEAU COVER, and hereby incorporates subject matter of the provisional application in its entirety.

### BACKGROUND OF THE INVENTION

The rapid increasing AI and Autonomous Driving Technologies drives the new generation of vehicles to be more automated and more personalized for versatile functions for today's users.

Also, the energy conservation requirements are more critical nowadays because it is important for the electric vehicles' battery mileage, the increasing gas, diesel, and fuel cell prices, environmental benefits, and government policies. Therefore, the vehicle's aerodynamic design with lower drag coefficient value is important to save energy.

The existing truck bed cover or tonneau designs are portable, but they do not have aerodynamic design to save energy cost, and they are normally manual-operated.

The roll-top automatic bed tonneau cover, can be folded back to the vehicle roof area to allow the users to open and close truck bed, which has good aerodynamic design to solve above issues.

For Example, the Tesla Cybertruck's closed tonneau cover adds 25 Miles of range at 75 MPH based on the testing result (Refer from CAR AND DRIVER: Tesla Cybertruck's Closed Tonneau Adds 25 Miles of Range at 75 MPH, by Dan Edmunds, Mar. 16, 2024). But it has following limitations:
1. The vehicle must have permanent side bed walls to install the roll-top cover system and it cannot be deinstalled, which limited for certain usages that requires the opening of bed sides or extra cargo loading.
2. The structure is complicated and expensive.
3. It requires custom made for certain truck models, and it cannot be installed or retrofitted on different traditional truck beds, utility vehicle roof, and van roof.
4. It normally made by thin steel or metal pieces to keep its strength with mobility, which do not have thermal protection for cargos, equipment, robotics, or passengers.

All existing tonneau designs cannot convert a truck to be a different type of vehicle, such as a SUV or van. Also, the roof design of a SUV or a van cannot convert them to be a truck with open bed.

Here are the purposes and advantages about the Side-Foldable and Convertible Truck Bed Tonneau Cover-Roof system:
1. This cover-roof system can be installed or deinstalled on the top of truck bed or van roof for certain uses with opened bed top and bed sides to make a truck or van to be a convertible multifunction vehicle. Of cause, the additional truck bed and cargo space modification may also be required for the vehicle conversion, such as adding or removing seats, window, carpet, or equipment, as well as required compliance and homologation regulations.
2. It can be used either automatic or manual operation. Provide automated or remoted command and control for bed cover operation.
3. It can be installed or retrofitted on any truck beds or van roof with different sizes. Give vehicle a better aerodynamic structure with lower drag coefficient to save energy and reducing and wind noise, minimizing noise emission, and preventing undesired lift forces and other causes of aerodynamic instability at high speeds.
4. The cover-roof system with thermal materials protects the cargos, installed equipment, robotics, or passengers in the bed or cargo space from outside damage resources, such as rain, storm, sunshine, hail, snow, fog, dust, heat or other sources.
5. Secure the cargos, installed equipment, robotics, or passengers in the bed or cargo space during the on-road and off-road transportation.
6. Protect the cargos, installed equipment, robotics, and passengers in the bed or cargo space from to be seen or stolen.
7. It can provide Solar Charge for the vehicle when the cover material utilizes the solar panels and solar charging system.
8. It provides a convertible vehicle solution to transform the truck to be a SUV or Van, or transform an SUV or van into a truck, greatly enhancing the vehicle's versatility and adaptability for different usages.
9. The folding panels can use tinted glass material and turn the tonneau cover to be a Panoramic Roof for the vehicle to increase the Utility and Aesthetic Value for vehicles.

### SUMMERY

This utility patent presents a Side-Foldable and Convertible Truck Bed Tonneau Cover-Roof System, offering an innovative solution for vehicle multifunctional conversion, energy efficiency, and cargo area protection.

The system features an automated, side-foldable tonneau cover that also functions as a roof, significantly enhancing aerodynamic efficiency, reducing energy consumption, and improving fuel economy. It provides robust weather protection and heightened security in the truck bed or cargo area for cargo, installed equipment, robotics, and passengers. With a one-touch operation, the system allows for smooth, seamless opening and closing, ensuring convenience and ease of use. This innovative design offers versatile functionality, transforming the tonneau cover into a portable vehicle roof. Additionally, it enables the conversion of a truck into various vehicle types, such as an SUV or van, or allows an SUV or van to be transformed into a truck, greatly enhancing the vehicle's versatility and adaptability.

The system consists of three key components: watertight tonneau roof panels (typically 4 or 6), a motorized folding and retracting mechanism, and an automated side-pocket storage solution for the folded panels. The side pockets, located along the truck bed walls or van walls, allow for partial or full access to the bed or cargo area while securely storing the panels.

The system can be installed as an original feature, retrofitted, or added as a portable upgrade on various vehicles with truck beds or cargo spaces, including trucks, pickup trucks, utility vehicles, passenger van, cargo van, and specialty vehicles, making it adaptable to a wide range of applications. This utility design provides both functional and aesthetic flexibility, allowing vehicles to be easily transformed based on user needs.

### BRIEF DESCRIPTION OF THE DRAWINGS

A brief description of all Figures is as follows:

FIG. 1 is the foldable cover-roof panels. Here is the 4-piece cover-roof panel module. There are two foldable pieces on both sides. The self-locking rubber seal with magnetic seal locking is structured in the middle opening side to provide a vacuum sealer quality closure with a self-latch mechanism for safety and security.

FIG. 2 is the view of a truck when the bed skirt and side-foldable bed cover-roof system removed. This system is portable and can be de-installed easily per user's needs.

FIG. 3 is a truck with bed skirt and side-foldable tuck bed cover at their closed position. The side-foldable tuck tonneau bed cover-roof are installed in the side pockets on bed wall skirts on both sides of the bed wall, which are either power open-close or manual open-close. The side pocket covers on both sides are closed as shown.

FIG. 4 is a top view of the side pockets, bed skirt, and side-foldable tuck bed cover-roof at closed position on a truck.

FIG. 5 is a view of the side-foldable tuck bed cover-roof system on a truck at its opening position, but the side pocket covers are still open for the transition of panel opening or closing. The cover-roof panels are folded at the inside of the side pockets on bed skirt and hidden in the inside of the bed wall. The side pockets cover is located at the outside and top of the bed skirt, which can secure the folded panels in its pocket on both sides to protect the folded cover-roof system.

FIG. 6 is a closer view of the side-foldable tuck bed cover-roof system at the middle of its opening or closing transition, and the side pocket/bed skirt cover is at its open position.

FIG. 7 shows the back end of side-foldable tuck bed cover-roof system at the middle of its opening or closing transition position.

FIG. 8 shows the interior view of folded bed cover panels at its side storage pocket located on the inside part of bed skirt, and the side pocket/bed skirt cover is at its open position.

FIG. 9 shows the exterior view of folded bed cover at its side storage pocket located on the inside part of bed skirt, and the side pocket/bed skirt cover is at its open position.

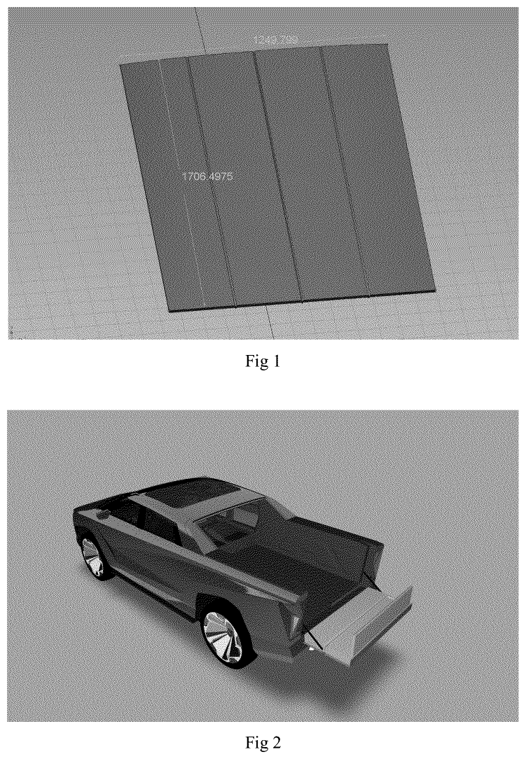

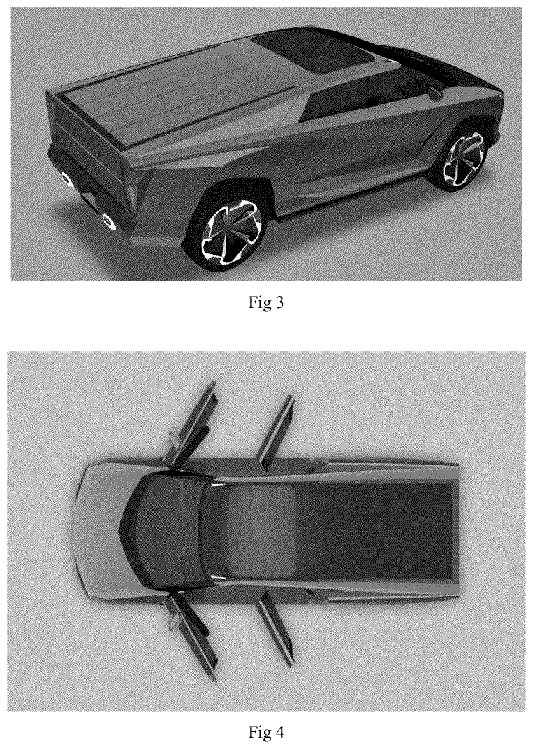

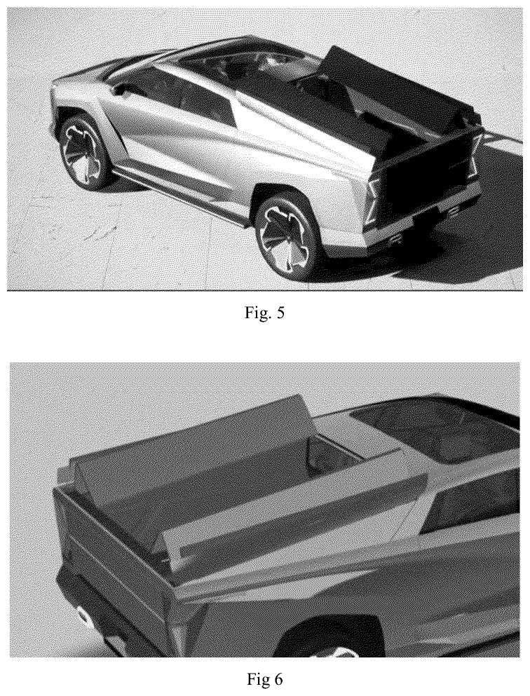

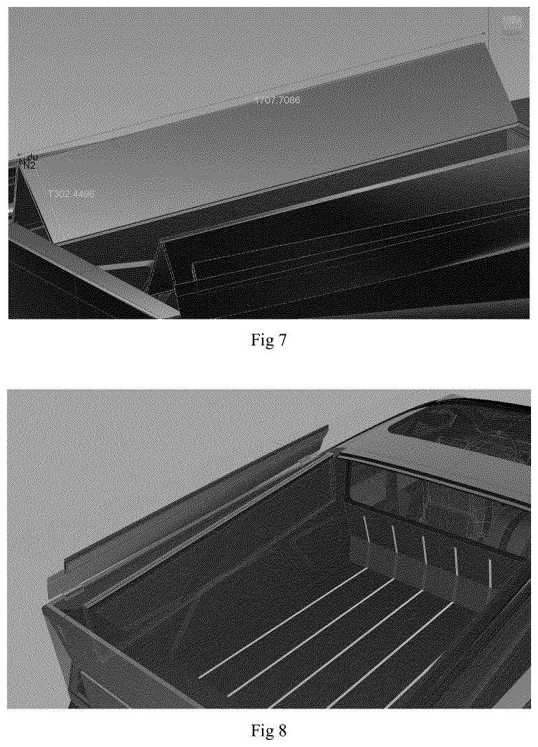

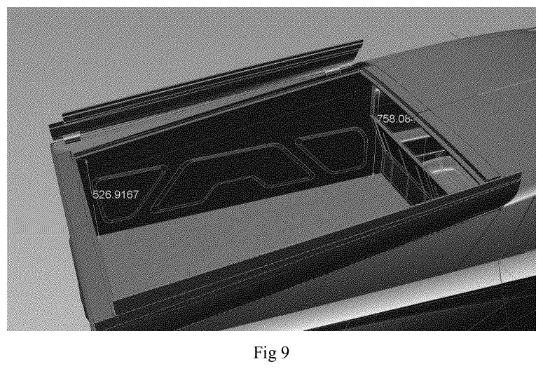

### DETAILED DESCRIPTIONS

The side-foldable and packable truck bed cover-roof is installed on a specially designed structure named the side pockets on the bed wall skirt, which is installed on the top of truck bed walls or van walls from the back-edge of the roof top to the truck bed end. Below are the details:
1. The cover-roof can be opened and closed by electric power (12V DC or 24 VDC) with either the control at driver's central control display, switch button on vehicle, or remote key. The electric power can be obtained from vehicle's low battery system. For the power open-close function, the cover-roof system equips an electric motor-powered mechanism to fold or open the cover panels.
2. The cover-roof can also be capable for manual open-close with handles.
3. The power open-close function structured sensors, sound and light alarm signal, and slow-motion operation to ensure the safety for user and the cargos, equipment, and passengers inside. If there are some of the cargos or equipment higher than the flat closed level of the cover-roof panels, the system will detect them and will not close the cover panels. It will generate an alert to user or driver to let them to decide how to do about the cargos, either rearrange them, or keep the cover partially closed.
4. The opening part is lockable by locking devices.
5. The cover-roof system can be portable, which can be easily installed or deinstalled from bed walls or cargo room walls. It also can be permanently installed from vehicle original build
6. The cover-roof material can be either steel, alloy, glass, fiberglass, carbon fiber, plastic, solar panel, wood, or other materials with thermal protection materials.
7. The cover-roof divided as two symmetrical portions for the both bed sides and open in the middle. Each part has two, three or more pieces of foldable panels. Although more pieces of fold panels could be added, the thickness of the folding pieces shall be a consideration with the bed wall thickness.
8. The folding panels connected by either hinges or the easy-foldable soft materials.
9. The foldable panels can be retracted into the side pocket in the inside of the bed skirt or cargo room wall and sealed inside.
10. The edges and connect parts of the cover-roof panels use rubber-magnetic self-seal mechanism to provide a vacuum sealer quality closure to seal the gaps to avoid the damage from the water, snow, dust, or any other sources.
11. The middle opening part of the cover-roof panels can be closed and secured with self-locking rubber seal with magnetic seal locking to provide a vacuum sealer quality closure with a self-latch mechanism for safety and security.
12. There is a side pocket/bed skirt cover located at the outside of the bed skirt on both sides, which secures the folded cover-roof panels in its pocket on both sides to protect the system when it's at the folded (open roof top) position and the closed (close roof top

What is claimed is:

1. I CLAIM: The ornamental invention and designs for Side-Foldable and Convertible Truck Bed Tonneau Cover-Roof System as shown and described in the Patent Specification Sheet, Abstract, and List of Drawings, and any required document submitted.
